(19) United States
(12) Patent Application Publication
(10) Pub. No.: US 2012/0236058 A1
(43) Pub. Date: Sep. 20, 2012

(54) INK JET PRINTING APPARATUS AND METHOD FOR MANUFACTURING PRINTED SUBSTANCE

(75) Inventor: Makoto NAGASE, Shiojiri-shi (JP)

(73) Assignee: SEIKO EPSON CORPORATION, Tokyo (JP)

(21) Appl. No.: 13/417,542

(22) Filed: Mar. 12, 2012

(30) Foreign Application Priority Data
Mar. 16, 2011 (JP) 2011-058375

(51) Int. Cl. B41J 2/205

(52) U.S. Cl. 347/15

(57) ABSTRACT

In printing on a material to be printed having fluff, printing with high image quality is performed while maintaining the texture of the fluff. An ink jet printing apparatus has a first printing head having an ink nozzle array for ejecting an ink containing a color material, a second printing head having a clear liquid nozzle array for ejecting a clear liquid not containing a color material and having better wettability to the material to be printed than the ink, and a control portion which controls the ejection of the ink and the clear liquid, in which the control portion has a printing execution mode in which either the ink or the clear liquid is ejected, and thereafter the other one is ejected thereon while the printing heads are relatively moving in one direction over a predetermined range of the material to be printed.

### INCORPORATION BY REFERENCE

This application claims the benefit of Japanese Patent Application No. 2011-058375, filed on Mar. 16, 2011, which is hereby incorporated by reference herein in its entirety.

### BACKGROUND

1. Technical Field

The present invention relates to an ink jet printing apparatus which performs printing on materials to be printed, such as cotton, silk, wool, chemical fiber, and blended yarn, by ejecting an ink from an ink jet recording head and a method for manufacturing a printed substance.

2. Related Art

When printing is performed on the materials to be printed, such as cotton, silk, wool yarn, chemical fiber, and blended yarn, a screen printing method using a printing die or a roller printing method using an engraved roller in which a pattern is engraved has been used heretofore. According to these printing methods, since an expensive printing die or engraved roller has been used, the cost is not justified unless printed substances are mass-produced.

In contrast, according to printing by an ink jet method, since the above-mentioned printing die, engraved roller, or the like is not required and printing is performed utilizing digital design data, printing of a small amount of production lot can be performed and also small design changes can be promptly handled thereby sharply shorten the production time. Moreover, there is an advantage that a degree of freedom of designs is high, e.g., color gradation can be expressed. For example, a small amount of original products can be produced by printing digital image data, such as photographs, on clothes, such as T-shirts, small articles made of cloth, and the like.

In the above-described respects, an ink jet printing method including performing printing by an ink jet method has drawn attention.

Herein, since the above-described materials to be printed are formed of a cloth, fluff is usually present on the cloth surface. Moreover, there is a cloth in which fluff on the cloth surface is increased by napping treatment or the like, so that the feeling is further softened by the increased fluff to add a texture and further a heat retaining property is increased by the increased fluff.

When ink jet printing is performed on the materials to be printed having fluff, some of ink droplets ejected from a printing head do not reach to the surface of a cloth body and adhere to the fluff in the shape of a lump to form an “ink lump” in many cases. When the “ink lump” is dried and solidified as it is, the abrasion resistance is reduced to cause a problem of color transfer.

Since the “ink lump” adheres to fluff rising from the cloth body surface, the “ink lump” is located at a position upper than a position of the cloth body surface which is a dyeing position, to which the ink is originally to adhere. Therefore, the presence of the “ink lump” causes a problem that the quality of a printed substance decreases.

The above-described problem tends to noticeably appears in a pigment ink having color material particles larger than those of a dye ink.

JP-A-2009-215506 or JP-A-2009-057452 discloses compounding a resin in the above-mentioned pigment ink to thereby increase the fixability of the ink to a cloth of a material to be printed and the washing fastness or the abrasion resistance of the manufactured printed substance. Since the addition of resin increases the viscosity of an ink, it is considered that the “ink lump” is more likely to form.

Moreover, in printing on the materials to be printed having fluff, not only clear printing of a printed pattern, image, or the like but maintaining a feeling, such as touch to the skin or texture, of raw materials of the materials to be printed as it is important to evaluate the quality of the printed substance.

### SUMMARY

An advantage of some aspects of the invention is to prevent an ink from adhering in the shape of a “lump” to the tip of fluff of a material to be printed in printing on the material to be printed and enable printing with high image quality in a state of maintaining the napped state of the fluff.

In order to solve the above-described problems, an ink jet printing apparatus according to a first embodiment of the invention has a first printing head having an ink nozzle array for ejecting an ink containing a color material, a second printing head having a clear liquid nozzle array for ejecting a clear liquid not containing a color material and having better wettability to a material to be printed than the ink, and a control portion which controls the ejection of the ink and the clear liquid, in which the control portion has a printing execution mode in which either the ink or the clear liquid is ejected, and thereafter the other one is ejected thereon while the printing heads are relatively moving in one direction over a predetermined range of the material to be printed.

Herein, the “material to be printed” means a “cloth”, “clothes and other accessories”, and the like to be printed. The cloth includes textiles, knitted substances, nonwoven fabrics, and the like of natural fibers, such as cotton, silk, and wool, chemical fibers, such as nylon, or a mixture thereof, and includes both a long one rolled in the shape of a roll and one cut into a predetermined length.

The “clothes and other accessories” include T-shirts after sewing, handkerchiefs, scarves, towels, handbags, bags made of cloth, furniture, such as curtains, sheets, and bedcovers, and the like and, in addition, cloth and the like before and after cutting present as parts before sewing.

The “surface of a cloth body” means a surface on a printing side of a cloth body which forms the fundamental external shape of the materials to be printed by being subjected to weaving processing, knitting processing, or the like or intertwining fibers without the processing among the materials to be printed.

The “fluff” includes fluff increased by napping on the surface of the cloth body and fluff naturally generated by the weaving processing.

The “ink” refers to a liquid which contains a color material and can form an image by being fixed to the material to be printed. The “clear liquid” refers to a liquid which is constituted by almost the same components as those of the “ink” except that the color material is not contained and which can fix a clear layer which is almost colorless to the material to be printed.

According to this embodiment, while the printing heads are relatively moving in one direction over a predetermined range of the material to be printed, i.e., one pass, both the ink and the clear liquid can be ejected, and then either printing in which the clear liquid is ejected on the ink which is ejected first or printing in which the ink is ejected on the clear liquid which is ejected first can be performed.

Herein, in the case where printing is performed on the surface of the cloth body of the material to be printed having fluff, when the ink is ejected first, the ink droplets of the ink adhere around the vicinity of the tip of the fluff to form “ink lump” in some cases. According to this embodiment, even when the ink lump is formed due to the previously ejected ink, liquid droplets of the clear liquid having better wettability to the material to be printed than the ink immediately after ejecting the ink. Therefore, the ink lump is moved to the lower portion of the fluff (at the side of the cloth body surface) with the clear liquid to reach a position of the cloth body surface which is a dyeing position to which the ink is originally to adhere (FIGS. 1A to 1C).

When the clear liquid having better wettability to the material to be printed than the ink is ejected first, the clear liquid reaches the root of the fluff along the fluff, i.e., the above-described position of the cloth body surface. Immediately thereafter, the ink droplets land. In this case, a small amount of the clear liquid remains on the fluff surface or the fluff surface is wet with the clear liquid. Therefore, the ink droplets are difficult to form the ink lump at the tip of the fluff and easily reach the original dyeing position (FIGS. 2A to 2C).

Due to the advantages described above, in the printing on the material to be printed having fluff, the formation of the ink lump adhering to the vicinity of the tip of the fluff is suppressed and printing with high image quality can be achieved in a state where the napped state of the fluff is maintained.

In an ink jet printing apparatus according to a second embodiment, the control portion has a first printing execution mode in which the ink and the clear liquid are ejected in the stated order in the first embodiment.

According to this embodiment, the same effect as in the first embodiment obtained in the case where the ink is ejected first, and then the clear liquid is ejected thereon can be obtained.

In an ink jet printing apparatus according to a third embodiment of the invention, the control portion has a second printing execution mode in which the clear liquid and the ink are ejected in the stated order in the first embodiment or the second embodiment.

According to this embodiment, the same effect as in the first embodiment obtained in the case where the ink is ejected first, and then the clear liquid is ejected thereon can be obtained.

In an ink jet printing apparatus according to a fourth embodiment of the invention, the first printing execution mode is carried out on a material to be printed, and thereafter the second printing execution mode is carried out at the same position of the material to be printed in the third embodiment.

According to this embodiment, the first printing execution mode is performed on the material to be printed, overprinting by the second printing execution mode can be performed at the same position of the material to be printed.

More specifically, when one pass printing in which the printing heads are relatively moved in a predetermined range of the material to be printed is performed twice at the same position, the ink is ejected first, and then the clear liquid is ejected thereon in the first printing, and then the clear liquid is ejected first, and thereafter the ink is ejected thereon in the second printing.

When the first printing is performed by the first printing execution mode, the clear liquid is ejected first. Therefore, immediately after finishing the first printing, a small amount of the clear liquid remains on the surface of fluff or the surface of fluff is wet with the clear liquid. When performing overprinting at the same position of the material to be printed, there is usually a time lag between the first printing and the second printing. Therefore, the clear liquid remaining on the fluff surface is slightly dried but partially remains thereon. Therefore, when the second printing is performed by the second printing execution mode, i.e., the mode in which the clear liquid is ejected first, the clear liquid remaining on the fluff surface can be utilized. Therefore, the amount of the clear liquid to be ejected first in the second printing mode can be reduced in the second printing execution mode.

An ink jet printing apparatus according to a fifth embodiment of the invention has, in the third embodiment or the fourth embodiment, a third printing execution mode in which the ink is ejected while the printing heads are passing over the predetermined range of the material to be printed in one direction and a fourth printing execution mode in which the clear liquid is ejected while the printing heads are passing over the predetermined range of the material to be printed in one direction, in which some modes of the first printing execution mode to the fourth printing execution mode are combined to realize printing at the same position of the material to be printed.

According to this embodiment, printing only with the ink and printing only with the clear liquid can be achieved by providing the third printing execution mode and the fourth printing execution mode.

Depending on an ink color type, the ink lump is hard to generate in some cases. Printing with such an ink color type does not require overprinting of the clear liquid in some cases. Moreover, by printing with the clear liquid alone, a clear layer with the clear liquid is formed. The clear layer can be used for coating the surface of the material to be printed before printing with an ink, coating the surface of an image formed by printing with an ink, or the like.

According to this embodiment, in addition to the same effect as that of the third embodiment or the fourth embodiment, printing in accordance with a color type of an ink, a type of a material to be printed, or the like to be used for printing can be achieved by combining some of the first printing execution mode to the fourth printing execution mode.

In an ink jet printing apparatus according to a sixth embodiment of the invention, the control portion has a mode of carrying out printing while changing the dot size of the ink and/or the clear liquid to be ejected from the printing heads in any one of the first embodiment to the fifth embodiment.

According to this embodiment, printing in which the dot size of either the ink or the clear liquid or both the ink and the clear liquid to be ejected from the printing heads is changed can be achieved. Thus, the dot size can be changed in accordance with the state of fluff of the cloth body surface of the material to be printed, for example. Moreover, as described in the fourth embodiment, when performing printing in which the liquid is ejected twice in a lamination manner while setting a time lag, the dot size can be changed to reduce the amount of the second clear liquid.

In an ink jet printing apparatus according to a seventh embodiment of the invention, each array of the ink nozzle array and the clear liquid nozzle array is arranged in a direction crossing the one direction in which the printing mode is performed and the clear liquid nozzle array is arranged at both sides of at least one color type of the ink nozzle array in any one of the first embodiment to the sixth embodiment.

According to this embodiment, since the clear liquid nozzle array is disposed at both sides of the ink nozzle array, one pass overprinting with the ink to be ejected from the ink nozzle array and the clear liquid can be effectively performed.

An ink jet printing apparatus according to an eighth embodiment of the invention, an ink color type of a nozzle array at both sides of which the clear liquid nozzle arrays are arranged is black in the seventh embodiment.

There is a tendency that a black ink is likely to form an “ink lump” particularly on the fluff of the surface of the material to be printed. According to this embodiment, a printed substance with high image quality can be obtained while suppressing the formation of the ink lump which is likely to generate in a black ink and not deteriorating the texture of fluff.

According to a method for manufacturing a printed substance according to a ninth embodiment of the invention, a printed substance is manufactured by performing printing by the ink jet printing apparatus according to any one of the first embodiment to the eighth embodiment.

According to this embodiment, the same effect as that of any one of the first embodiment to the eighth embodiment is demonstrated and the adhesion of an ink to the tip of the fluff of the material to be printed in the shape of a “lump” is prevented when performing ink jet printing on the material to be printed, so that a printed substance with high image quality can be obtained without deteriorating the texture of the fluff.

### BRIEF DESCRIPTION OF THE DRAWINGS

The invention will be described with reference to the accompanying drawings, wherein like numbers reference like elements.

FIGS. 1A to 1C are enlarged views of the surface of a material to be printed for use in the description of printing by an ink jet printing apparatus according to an aspect of the invention, in which FIG. 1A is a view illustrating a state immediately after an ink ejected first lands on the surface of the material to be printed, FIG. 1B is a view illustrating a state where a clear liquid is ejected after the ink, and FIG. 1C is a view illustrating a state of the surface of the material to be printed after the clear liquid lands.

FIGS. 2A to 2C are enlarged views of the surface of a material to be printed for use in the description of printing by an ink jet printing apparatus according to an aspect of the invention, in which FIG. 2A is a view illustrating a state immediately after a clear liquid ejected first lands on the surface of the material to be printed, FIG. 2B is a view illustrating a state where an ink is ejected after the clear liquid, and FIG. 2C is a view illustrating a state of the surface of the material to be printed after the ink lands.

FIG. 3 is a schematic view illustrating an example of an ink jet printing apparatus according to an aspect of the invention.

FIG. 4 is a plan view illustrating an example of a printing head for use in an ink jet printing apparatus according to an aspect of the invention.

FIG. 5 is a plan view illustrating another example of a printing head for use in an ink jet printing apparatus according to an aspect of the invention.

### DESCRIPTION OF EXEMPLARY EMBODIMENTS

Hereinafter, the invention is described in detail with reference to Examples. The invention is not limited thereto.

First, an ink and a clear liquid for use in an ink jet printing apparatus according to an aspect of the invention are described.

### Ink

As an ink for use in printing, a pigment ink having excellent preservability, such as lightfastness and water resistance, is preferably used. A known pigment ink can be used which contains a color material, a resin added in order to increase abrasion resistance or the like, and other components at least containing a solvent. As the color material, well-known pigments, i.e., organic pigments, inorganic pigments, carbon black, and the like, can be used.

For example, as a black color ink, carbon blacks (C.I. pigment black 7), such as furnace black, lamp black, acetylene black, and channel black, are particularly preferable. Metals, such as copper oxide, iron oxide (C.I. pigment black 11), and titanium oxide, and organic pigments, such as aniline black (C.I. pigment black 1), can also be used.

Usable as pigments for a color ink are C.I. pigment yellow 1 (Fast Yellow G), 3, 12 (Disazo Yellow AAA), 13, 14, 17, 24, 34, 35, 37, 42 (Yellow Iron Oxide), 53, 55, 74, 81, 83 (Disazo Yellow HR), 93, 94, 95, 97, 98, 100, 101, 104, 108, 109, 110, 117, 120, 128, 138, 153, 155, 180, and 185, C.I. pigment red 1, 2, 3, 5, 17, 22 (Brilliant Fast Scarlet), 23, 31, 38, 48:2 (Permanent Red 2B (Ba)), 48:2 (Permanent Red 2B (Ca)), 48:3 (Permanent Red 2B (Sr)), 48:4 (Permanent Red 2B (Mn)), 49:1, 52:2, 53:1, 57:1 (Brilliant Carmine 6B), 60:1, 63:1, 63:2, 64:1, 81 (Rhodamine 6G rake), 83, 88, 101 (Indian Red), 104, 105, 106, 108 (Cadmium Red), 112, 114, 122 (Quinacridone Magenta), 123, 146, 149, 166, 168, 170, 172, 177, 178, 179, 185, 190, 193, 202, 206, 209, and 219, C.I. pigment violet 19 and 23, C.I. pigment orange 36, C.I. pigment blue 1, 2, 15 (Phthalocyanine Blue R), 15:1, 15:2, 15:3 (Phthalocyanine Blue G), 15:4, 15:6 (Phthalocyanine Blue E), 16, 17:1, 56, 60, and 63, C.I. pigment green 1, 4, 7, 8, 10, 17, 18, and 36, and the like can be used.

The content of the color material in the ink is preferably 0.5% to 30% and more preferably 1.0% to 15%. When the addition amount is equal to or smaller than the above-mentioned range, a printing concentration cannot be secured. When the addition amount is equal to or larger than the above-mentioned range, the viscosity of the ink increases or structural viscosity occurs in the viscosity characteristics of the ink, so that the ejection stability of the ink from an ink jet printing head tends to deteriorate.

Next, the resin is described. The resin is added for the purpose of mainly increasing the washing fastness, abrasion resistance, and fixability of the ink. A known resin, e.g., a resin component described in JP-A-2006-307165, for example, can be used. Specifically, a composite component resin of a hydrophilic resin and a hydrophobic resin can be used. Usable as the hydrophilic resin are styrene acrylic resin having a hydrophilic group, such as a carboxy group and a sulfone group, silicone resin, polyester resin, urethane resin, and the like. Usable as the hydrophobic resin are styrene acrylic resin, silicone resin, polyester resin, urethane resin, and the like which show hydrophobicity.

Moreover, the resin can be manufactured by a known method, e.g., a method described in JP-A-2010-189626 (Method for producing polymer fine particles).

The glass transition temperature of the resin is preferably 0° C. or lower. Thus, the fixability of a pigment as a printing ink improves. When the glass transition temperature exceeds 0° C., the fixability of the pigment gradually decreases. The glass transition temperature is preferably −5° C. or lower and more preferably −10° C. or lower. The acid value of the resin is preferably 100 mgKOH/g or lower. When the acid value exceeds 100 mgKOH/g, the washing fastness when printing is performed on a material to be printed decreases. The acid value is preferably 50 mgKOH/g or lower and more preferably 30 mgKOH/g or lower. The molecular weight of the resin is preferably 100,000 or more and more preferably 200,000 or more. When the acid value is lower than 100,000, the washing fastness when printing is performed on a material to be printed decreases.

The content of the resin in the ink is preferably 10% by weight or lower. By adjusting the resin content in the ink to 10% by weight or lower, the solidification of the ink at a printing head nozzle can be prevented and the viscosity of the ink can be adjusted to a viscosity at which the ink can be stably ejected.

Next, other components other than the color material and the resin are described. The other components are components at least containing a solvent and can contain, for example, a solvent, such as 1,2-hexanediol, butyltriglycol, glycerin, trimethylolpropane, triethyleneglycol, and triethanolamine, a surfactant, ion exchanged water, and the like. Usable as the surfactant are known surfactants, such as an acetylene glycol-based surfactant and an acetylene alcohol-based surfactant (e.g., JP-A-2010-189626).

Moreover, for the purpose of securing storage stability, stable ejection from an ink jet head, a prevention of clogging, or a prevention of ink degradation, and the like, various additives, such as moisturizers, dissolution auxiliary agents, penetration control agents, viscosity adjusters, pH adjusters, dissolution auxiliary agents, antioxidants, antiseptics, antifungal agents, corrosion prevention agents, and chelate for capturing a metal ion having influence on dispersion, can also be added.

### Clear Liquid

As a clear liquid for use in the invention, a liquid can be used which is constituted by almost the same components as the ink except containing the color material in the ink.

For example, when using a liquid, to which the color material in the ink is not added, as it is as the clear liquid, the viscosity decreases because the color material is not contained. A surfactant is contained as the components other than the color material as described above. The content (e.g., % by weight) of the surfactant becomes relatively high due to the fact that the color material is not added. Therefore, the wettability to a material to be printed becomes good and the clear liquid have wettability capable of wetting fluff of the material to be printed.

The clear liquid is preferably one which can be used for forming a coating covering the surface of a cloth body of a material to be printed before printing or the ink surface after printing with a clear layer by printing the clear liquid alone.

When the clear liquid is used for coating as described above, the clear liquid is required to have washing fastness, abrasion resistance, and fixability higher than those of the ink. In such a case, a large amount of the resin which is added for the purpose of improving the abrasion resistance and the like can be compounded in the clear liquid. When a large amount of the resin is compounded, the wettability deteriorates in some cases. However, the wettability can be adjusted by changing the type or amount of the surfactant.

### Example 1

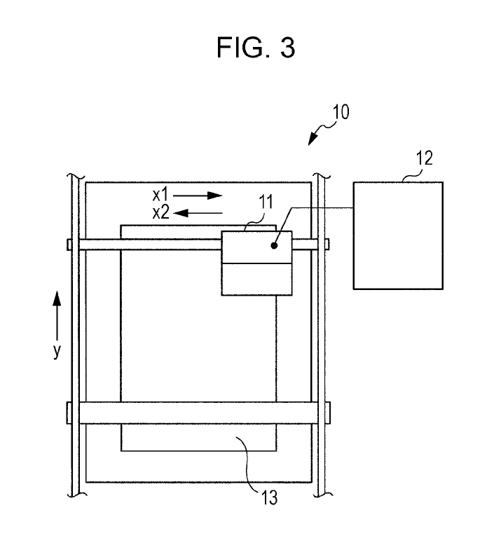

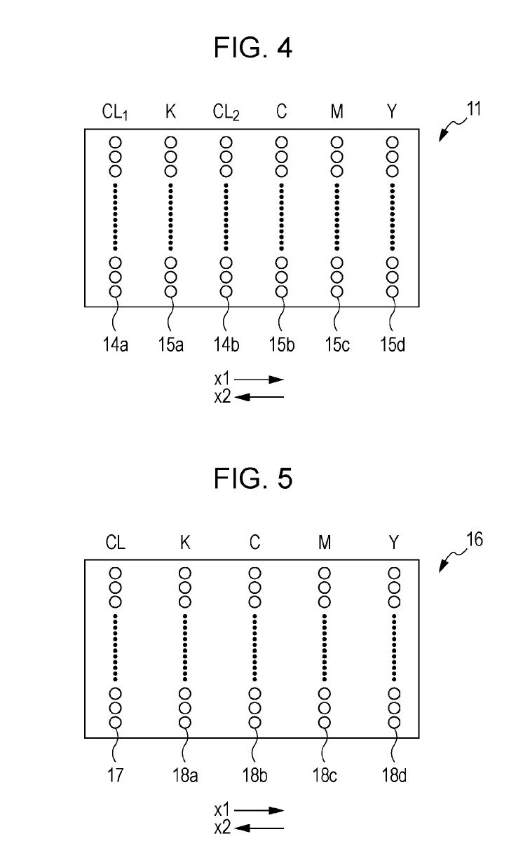

Hereinafter, examples of the invention are described with reference to the drawings. FIG. 3 is a schematic view illustrating an example of an ink jet printing apparatus according to an aspect of the invention. FIG. 4 is a plan view illustrating an example of a printing head for use in an ink jet printing apparatus according to an aspect of the invention.

An ink jet printing apparatus 10 according to an aspect of the invention has a printing head 11 which is constituted in such a manner as to reciprocate to the width direction (the direction of a shorter side of a material to be printed 13) of the material to be printed 13 and a control portion 12 which controls ejection of each of a clear liquid and an ink from nozzle array provided in the printing head 11. x1 and x2 represent the movement directions of the printing head and y represents a transportation direction of the material to be printed 13.

In this example, first, the printing head 11 which can carry out printing in a single direction by the reciprocation movement is described.

As illustrated in FIG. 4, the printing head 11 has a nozzle array 14a and a nozzle array 14b which eject the clear liquid (CL₁ and CL₂ in FIG. 4) and a nozzle array 15a, a nozzle array 15b, a nozzle array 15c, and a nozzle array 15d which eject inks of various colors [Y (yellow), M (magenta), C (cyan), K (black) in FIG. 4]. Each nozzle array is arranged in a direction orthogonal to the axis direction of a carriage (movement direction x1 and movement direction x2 of the printing head) on which the printing head 11 is provided.

In this example, the nozzle array 14a and the nozzle array 14b which eject the clear liquid are disposed at both sides of the nozzle array 15a which ejects a black ink which is particularly likely to form an ink lump. Due to the fact that the nozzle arrays are arranged as described above, printing in a single direction is performed by the reciprocation movement. For example, when printing is performed while the printing head 11 is moving in the movement direction x1, both a first printing execution mode in which an ink (K) and a clear liquid (CL₁) are ejected in the stated order and a second printing execution mode in which a clear liquid (CL₂) and an ink (K) are ejected in the stated order can be carried out by the control portion 12 in one movement of the printing head 11.

The control portion 12 preferably has, in addition to the first printing execution mode and the second printing execution mode, a third printing execution mode in which the ink is ejected in one movement in the movement direction x1 of the printing head 11 and a fourth printing execution mode in which the clear liquid is ejected in one movement in the movement direction x1 of the printing head.

Next, the first printing execution mode and the second printing execution mode performed using the ink jet printing apparatus 10 of this example are described with reference to the drawings.

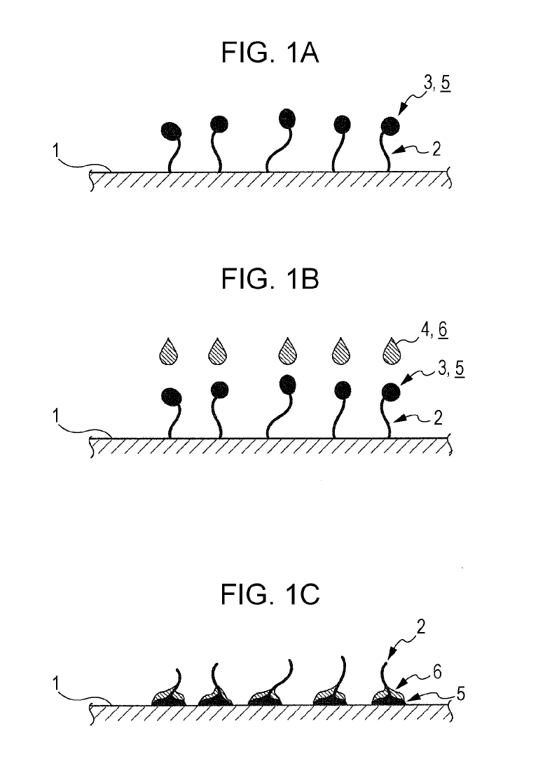

First, the first printing execution mode in which the ink and the clear liquid are ejected in the stated order is described. FIGS. 1A to 1C are enlarged views of the surface of a material to be printed for use in the description of printing by an ink jet printing apparatus according to an aspect of the invention, in which FIG. 1A is a view illustrating a state immediately after an ink ejected first lands on the surface of the material to be printed, FIG. 1B is a view illustrating a state where a clear liquid is ejected after the ink, and FIG. 1C is a view illustrating a state of the surface of the material to be printed after the clear liquid lands.

In the first printing execution mode, an ink 5 is ejected and a clear liquid 6 is ejected on the ink 5 while the printing head is moving in the movement direction x1 once. In this case, on the surface of a cloth body of a material to be printed 1 having fluff, the ink 5 ejected first adheres around the vicinity of the tip of a fluff 2 to form an “ink lump 3” in some cases [FIG. 1A]. In the first printing execution mode, since the clear liquid 6 is ejected for overprinting immediately after the ejection of the ink 5 as described above, a liquid droplet 4 of the clear liquid 6 lands on the ink lump 3 [FIG. 1B]. The clear liquid 6 having better wettability than that of the ink 5 downwardly presses to move the ink lump 3 at the tip of the fluff 2. Therefore, the ink 5 can reach a dyeing position (root of the fluff 2) of the material to be printed 1 where the ink is to adhere [FIG. 1C].

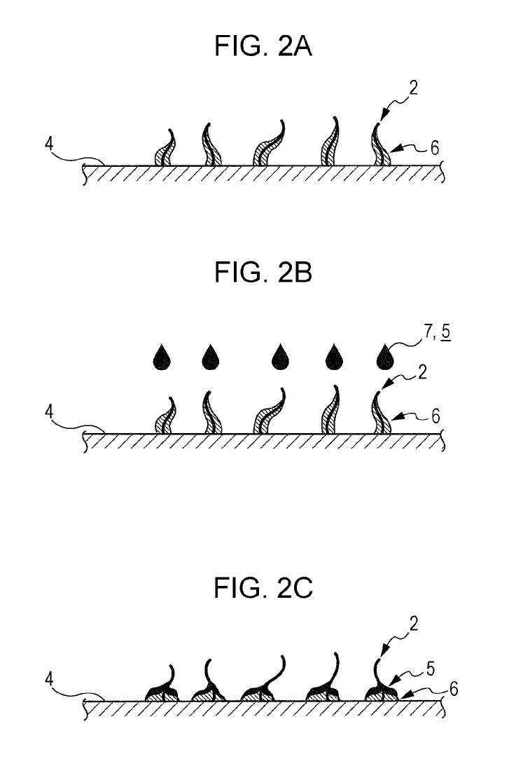

Next, the second printing execution mode in which the clear liquid and the ink are ejected in the stated order is described. FIGS. 2A to 2C are enlarged views of the surface of a material to be printed for use in the description of printing by an ink jet printing apparatus according to an aspect of the invention, in which FIG. 2A is a view illustrating a state immediately after a clear liquid ejected first lands on the surface of the material to be printed, FIG. 2B is a view illustrating a state where an ink is ejected after the clear liquid, and FIG. 2C is a view illustrating a state of the surface of the material to be printed after the ink lands.

In the second printing execution mode, the clear liquid 6 is ejected and the ink 5 is ejected on the clear liquid 6 while a printing head is moving in the movement direction x1 once. In this printing execution mode, since the clear liquid 6 having good wettability to the material to be printed 1 is ejected before the ink 5, the clear liquid 6 reaches the root of the fluff 2 along the fluff 2, i.e., a dyeing position of the material to be printed 1 to which the ink 5 is originally to adhere [FIG. 2A]. Immediately thereafter, an ink droplet 7 lands thereon [FIG. 2B]. In this case, the clear liquid 6 remains on the surface of the fluff 2 or the surface of the fluff 2 is wet with the clear liquid 6. Therefore, the ink droplet 7 is difficult to form the ink lump 3 (see FIG. 1A to 1C) at the tip of the fluff 2 and easily reaches the original dyeing position [FIG. 2C].

As described above, by performing the first printing execution mode or the second printing execution mode, the formation of the ink lump 3 adhering around the vicinity of the tip of the fluff 2 of the material to be printed 1, and therefore printing with high image quality is achieved while maintaining the texture of the fluff 2 of the material to be printed 1.

In the printing on the material to be printed 1 having the fluff 2, a large amount of the ink 5 cannot be ejected at one time because the ink lump 3 is likely to form. Therefore, it is difficult to form a clear image by one pass printing. Accordingly, in usual, printing is performed twice or more at the same position of the material to be printed 1 to thereby form an image. In such a case, it is preferable to perform printing by the first printing execution mode, and thereafter performing printing by the second printing execution mode at the same position of the material to be printed.

More specifically, in performing the one pass printing twice at the same position, the ink 5 is ejected first, and thereafter the clear liquid 6 is ejected thereon in the first printing, and then the clear liquid 6 is ejected first, and thereafter the ink 5 is ejected thereon in the second printing.

When the first printing by the first printing execution mode is performed, the clear liquid 6 is ejected first. Therefore, immediately after finishing the first printing, a small amount of the clear liquid 6 remains on the surface of the fluff 2 or the surface of the fluff 2 is wet with the clear liquid 6. When performing overprinting at the same position of the material to be printed 1, there is usually a time lag between the first printing and the second printing, and therefore the clear liquid 6 remaining on the surface of the fluff 2 is slightly dried but partially remains thereon. Therefore, when the second printing is performed by the second printing execution mode, i.e., the mode in which the clear liquid 6 is ejected first, the clear liquid 6 remaining on the surface of the fluff 2 can be utilized. Therefore, the amount of the clear liquid 6 to be ejected in the second printing mode can be reduced. The amount of the ink or the clear liquid to be ejected can be adjusted by changing the dot size.

Depending on an ink color type, the ink lump is hard to generate in some cases. Printing with such an ink color type does not require overprinting of the clear liquid in some cases. Moreover, by printing with the clear liquid alone, a clear layer with the clear liquid is formed. The clear layer can be used for coating the surface of the material to be printed before printing with an ink, coating the surface of an image formed by printing with an ink, or the like.

Accordingly, by combining the third printing execution mode (ejection only the ink) and the fourth printing execution mode (ejecting only the clear liquid) with the first printing execution mode and the second printing execution mode, printing in accordance with an ink color type, a type of a material to be printed, or the like for use in printing can be performed.

### Example 2

FIG. 5 is a plan view illustrating another example of a printing head for use in an ink jet printing apparatus according to an aspect of the invention. In a printing head 16 illustrated in FIG. 5, a nozzle array 17 for a clear liquid is disposed only at one side of a nozzle array 18a for a black ink (K).

The printing head 16 can be used when performing printing in both directions by the reciprocation of the printing head 16. According to this example, when the printing head moves in the movement direction x1 to thereby carry out printing, printing in which the black ink is ejected first, and then the clear liquid is ejected thereon can be performed by one pass. Moreover, when the printing head moves in the movement direction x2 to thereby carry out printing, printing in which the clear liquid is ejected first, and the black ink is ejected thereon can be performed by one pass.

In the printing head 16 illustrated in FIG. 5, the nozzle array 17 for clear liquid and nozzle arrays 18a to 18d for various color inks are provided on the same printing head 16. A first printing head having the nozzle array 17 for clear liquid and a second printing head having the nozzle arrays 15a to 15d for various color inks can be separately provided.

Example 1 and Example 2 are examples of a serial printer in which printing is performed while moving the printing head 11 or the printing head 16 in a direction crossing the transportation direction y of the material to be printed. It is a matter of course that the invention can also be applied to a line printer which has a printing head on which nozzle arrays are formed in a direction crossing the transportation direction y of a material to be printed and in which the material to be printed is transported for printing.

The above description is a description of the ink jet printing apparatus and the method for manufacturing a printed substance of the invention. In ink jet printing on a material to be printed having fluff, the formation of an ink lump adhering around the vicinity of the tip of the fluff is suppressed, and thus printing with high image quality can be achieved while the napped state of the fluff is maintained.

What is claimed is:

1. An ink jet printing apparatus, comprising:
a first printing head having an ink nozzle array for ejecting an ink containing a color material;
a second printing head having a clear liquid nozzle array for ejecting a clear liquid not containing a color material and having better wettability to a material to be printed than the ink; and
a control portion which controls the ejection of the ink and the clear liquid,
the control portion having a printing execution mode in which either the ink or the clear liquid is ejected, and thereafter the other one is ejected thereon while the printing heads are relatively moving in one direction over a predetermined range of the material to be printed.

2. The ink jet printing apparatus according to claim 1, wherein the control portion has a first printing execution mode in which the ink and the clear liquid are ejected in the stated order.

3. The ink jet printing apparatus according to claim 1, wherein the control portion has a second printing execution mode in which the clear liquid and the ink are ejected in the stated order.

4. The ink jet printing apparatus according to claim 3, wherein the first printing execution mode is carried out on a material to be printed, and thereafter the second printing execution mode is carried out at the same position of the material to be printed.

5. The ink jet printing apparatus according to claim 3, comprising:
a third printing execution mode in which the ink is ejected while the printing heads are passing over the predetermined range of the material to be printed in one direction; and
a fourth printing execution mode in which the clear liquid is ejected while the printing heads are passing over the predetermined range of the material to be printed in one direction, wherein
some modes of the first printing execution mode to the fourth printing execution mode being combined to realize printing at the same position of the material to be printed.

6. The ink jet printing apparatus according to claim 1, wherein the control portion has a mode of carrying out printing while changing a dot size of the ink and/or the clear liquid to be ejected from the printing heads.

7. The ink jet printing apparatus according to claim 1, wherein each array of the ink nozzle array and the clear liquid nozzle array is arranged in a direction crossing the one direction in which the printing mode is performed, and
the clear liquid nozzle array is arranged at both sides of at least one color type of the ink nozzle array.

8. The ink jet printing apparatus according to claim 7, wherein an ink color type of a nozzle array at both sides of which the clear liquid nozzle arrays are arranged is black.

9. A method for manufacturing a printed substance, comprising:
manufacturing a printed substance by performing printing by the ink jet printing apparatus according to claim 1.

10. A method for manufacturing a printed substance, comprising:
manufacturing a printed substance by performing printing by the ink jet printing apparatus according to claim 2.

11. A method for manufacturing a printed substance, comprising:
manufacturing a printed substance by performing printing by the ink jet printing apparatus according to claim 3.

12. A method for manufacturing a printed substance, comprising:
manufacturing a printed substance by performing printing by the ink jet printing apparatus according to claim 4.

13. A method for manufacturing a printed substance, comprising:
manufacturing a printed substance by performing printing by the ink jet printing apparatus according to claim 5.

14. A method for manufacturing a printed substance, comprising:
manufacturing a printed substance by performing printing by the ink jet printing apparatus according to claim 6.

15. A method for manufacturing a printed substance, comprising:
manufacturing a printed substance by performing printing by the ink jet printing apparatus according to claim 7.

16. A method for manufacturing a printed substance, comprising:
manufacturing a printed substance by performing printing by the ink jet printing apparatus according to claim 8.
